(19) United States
(12) Patent Application Publication
(10) Pub. No.: US 2022/0001884 A1
(43) Pub. Date: Jan. 6, 2022

(54) VEHICLE-MOUNTED PROCESSING DEVICE OF LEARNING-USE DATA

(71) Applicant: TOYOTA JIDOSHA KABUSHIKI KAISHA, Aichi-ken (JP)

(72) Inventors: Yohei NAKANISHI, Susono-shi (JP); Kotoru SATO, Susono-shi (JP)

(21) Appl. No.: 17/319,097

(22) Filed: May 13, 2021

(30) Foreign Application Priority Data
Jul. 3, 2020 (JP) 2020-115696

(51) Int. Cl. B60W 50/06; G06N 3/08

(52) U.S. Cl. CPC B60W 50/06; B60W 2050/0014; G06N 3/08

(57) ABSTRACT

A vehicle-mounted processing device of learning-use data including a data acquisition unit acquiring data relating to operation of the vehicle, a neural network storage unit storing a neural network which outputs output values relating to operational control of the vehicle if data which was acquired at the data acquisition unit is input, and a learning-use data storage unit storing learning-use data of weights of the neural network. If the frequency of learning of the weights of the neural network on the vehicle or the frequency of transmission of the learning-use data to the server becomes lower, the amount of storage per unit time of the learning-use data successively stored in the learning-use data storage unit or the amount of the learning-use data which finishes being stored in the learning-use data storage unit is made to decrease.

### FIELD

The present invention relates to a vehicle-mounted processing device of learning-use data.

### BACKGROUND

Known in the art is a data collection system able to collect data relating to a surrounding environment of a vehicle or a state of the vehicle at a server by a suitable frequency of acquisition (for example, see Japanese Unexamined Patent Publication No. 2018-55191).

### SUMMARY

However, in this case, if the frequency of acquisition of the data is not high, it is necessary to store the data in a data storage unit of the vehicle until the data is collected. Therefore, if the storage capacity of the data storage unit is insufficient, the problem arises that it is not possible to store the required data.

According to the present invention, there is provided a vehicle-mounted processing device of learning-use data in which learning of weights of a neural network is performed on a vehicle or at a server outside of the vehicle, the vehicle-mounted processing device of learning-use data comprising:

a data acquisition unit acquiring data relating to operation of the vehicle,

a neural network storage unit storing a neural network which outputs output values relating to operational control of the vehicle if data which is acquired at the data acquisition unit is input,

a learning-use data storage unit storing learning-use data of weights of the neural network,

a frequency acquisition unit acquiring a frequency of learning of the weights of the neural network on the vehicle or a frequency of transmission of the learning-use data to the server, and

a learning-use data changing unit making an amount of storage per unit time of the learning-use data successively stored in the learning-use data storage unit or an amount of the learning-use data which finishes being stored in the learning-use data storage unit decrease if the frequency of learning of the weights of the neural network on the vehicle or the frequency of transmission of the learning-use data to the server becomes lower.

When the frequency of learning of the weights of the neural network on the vehicle or the frequency of transmission of the learning-use data to the server becomes lower, by making the amount of storage per unit time of the learning-use data successively stored in the learning-use data storage unit or the learning-use data which finishes being stored in the learning-use data storage unit decrease, it is possible to make the necessary learning-use data be stored in the learning-use data storage unit.

### BRIEF DESCRIPTION OF DRAWINGS

FIG. 1 is an overall view of a vehicle-mounted processing device of learning-use data.

FIG. 2 is a view of a functional configuration of a first example of machine learning.

FIG. 3 is a view of a functional configuration of a second example of machine learning.

FIG. 4 is a view showing one example of a neural network.

FIG. 5 is a view showing learning-use data sets.

FIG. 6A, FIG. 6B, and FIG. 6C are respectively views showing amounts of storage of the learning-use data.

FIG. 7A, FIG. 7B, FIG. 7C, and FIG. 7D are respectively views showing a relationship of an amount of storage per unit time of the learning-use data and a frequency of learning or a frequency of transmission, a relationship of a period of the cycle of acquisition of the learning-use data and a frequency of learning or a frequency of transmission, a relationship of types of the learning-use data and a frequency of learning or a frequency of transmission, and a relationship of a stored amount of the learning-use data and a frequency of learning or a frequency of transmission.

FIG. 8 is a view showing examples of learning-use data sets.

FIG. 9 is a view of the functional configuration of one example of a vehicle-mounted processing device according to the present invention.

FIG. 10 is a view of the functional configuration of one example of the vehicle-mounted processing device shown in FIG. 9.

FIG. 11 is a flow chart for storage of the learning-use data.

FIG. 12 is a flow chart for learning processing.

FIG. 13 is a flow chart for storage of the learning-use data.

FIG. 14 is a flow chart for storage of the learning-use data.

FIG. 15 is a view showing a view of the functional configuration of another example of a vehicle-mounted processing device shown in FIG. 9.

FIG. 16 is a flow chart for processing of the learning-use data.

FIG. 17A and FIG. 17B are respectively a view of the functional configuration of another embodiment of a vehicle-mounted processing device according to the present invention and a view showing a view of the functional configuration of the server.

FIG. 18 is a flow chart for processing for communication between the vehicle and the server.

FIG. 19 is a view showing a view of the functional configuration of one example of the vehicle-mounted processing device shown in FIG. 17A.

FIG. 20 is a flow chart for storage of the learning-use data.

FIG. 21 is a flow chart for storage of the learning-use data.

FIG. 22 is a flow chart for storage of the learning-use data.

FIG. 23 is a view showing a view of the functional configuration of another example of the vehicle-mounted processing device shown in FIG. 17A.

FIG. 24 is a flow chart for processing of the learning-use data.

### DESCRIPTION OF EMBODIMENTS

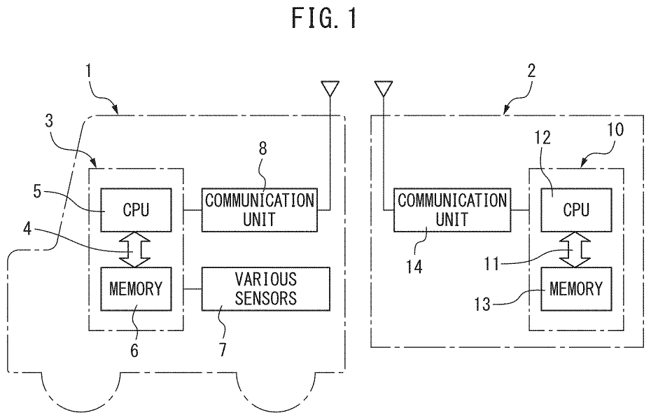

If referring to FIG. 1, 1 shows a vehicle and 2 shows a server. As shown in FIG. 1, an electronic control unit 3 is mounted inside the vehicle 1. This electronic control unit 3 is comprised of a digital computer and is provided with a CPU (microprocessor) 5 and a memory 6 comprised of a ROM and RAM, which are connected with each other by a bidirectional bus 4.

Various types of sensors 7 are connected to the electronic control unit 4. Further, a communication unit 8 for communicating with the server 2 is connected to the electronic control unit 4. On the other hand, an electronic control unit 10 is arranged inside the server 2. This electronic control unit 10 is comprised of a digital computer and is provided with a CPU (microprocessor) 12 and a memory 13 comprised of a ROM and RAM, which are connected with each other by a bidirectional bus 11. A communication unit 14 for communicating with the vehicle 1 is connected to the electronic control unit 10.

In an embodiment according to the present invention, the learning-use data is collected at the vehicle 1 and learning for preparing a learned model is performed based on the collected learning-use data. In this case, in an embodiment according to the present invention, sometimes a learned model is prepared at the vehicle 1, that is, is onboard learning is performed, and sometimes a learned model is prepared outside the vehicle 1, that is, the learned model is prepared at the server 2. Therefore, first, two examples where machine learning for preparing a learned model both can be performed on the vehicle 1 and outside the vehicle 1 will be briefly explained.

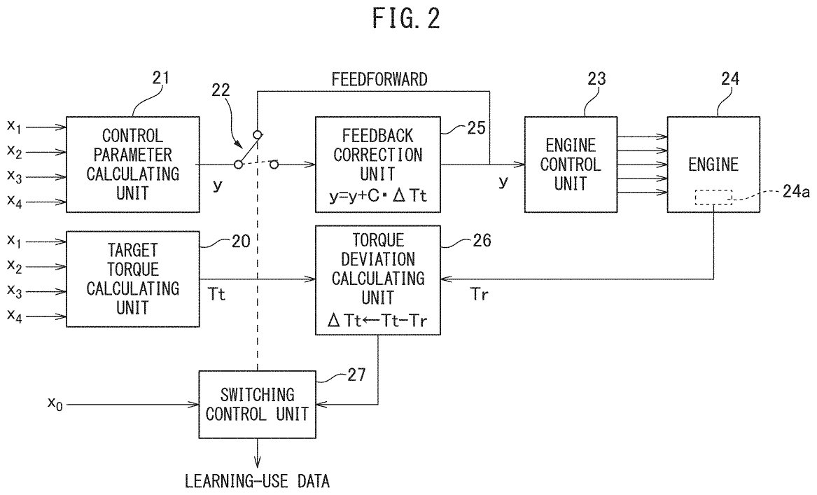

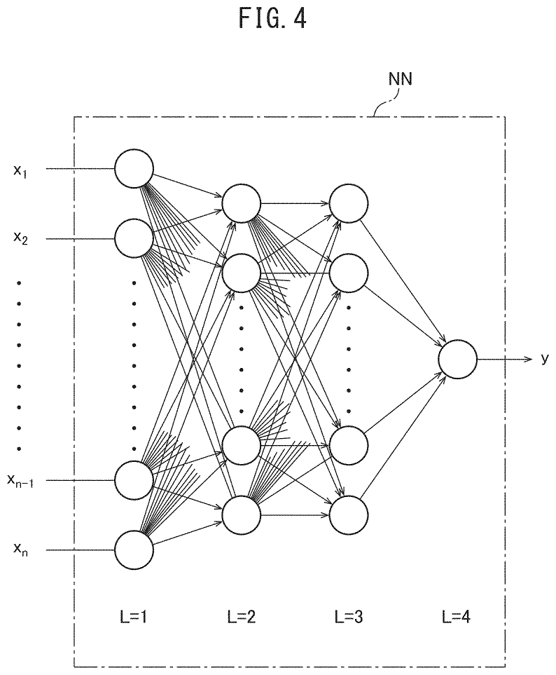

In FIG. 2, a view of the functional configuration of the first example is shown. If referring to FIG. 2, in this first example, a system is comprised of a target torque calculating unit 20, a control parameter calculating unit 21, a switching unit 22, an engine control unit 23 for controlling an engine 24 of the vehicle 1, a feedback correcting unit 25, a torque deviation calculating unit 26, and a switching control unit 27. Note that, at the engine 24, a torque sensor 24a for detecting an actual output torque Tr of the engine is attached. As shown in FIG. 2, the target torque calculating unit 20, for example, is configured by a neural network NN such as shown in FIG. 4. This target torque calculating unit 20 is configured to output the target torque Tt of the engine 24 if the input values x1 (accelerator opening degree), x2 (engine speed), x3 (air temperature), x4 (altitude) are input to the target torque calculating unit 20. Note that, in FIG. 4, L=1 indicates an input layer, L=2, L=3, and L=4 indicate hidden layers, and L=5 indicates an output layer. x1 to xn show input values to the nodes of the input layer (L=1), while “y” shows an output value from the node of the output layer (L=5).

On the other hand, the relationship of the fuel injection quantity, air-fuel ratio, ignition timing, intake valve timing, and exhaust valve timing and the target torque control value “y” of the engine 24d such that when inputting the target torque control value “y” of the engine 2 to the engine control unit 23, the actual output torque Tr of the engine 24 becomes the target torque Tt, is found in advance by experiments, and this relationship is stored in advance at the engine control unit 23. Therefore, normally, if the target torque control value “y” of the engine 24 is input to the engine control unit 23, the actual output torque Tr of the engine 24 becomes the target torque Tt. On the other hand, the control parameter calculating unit 21 also, for example, is comprised of a neural network NN such as shown in FIG. 4. This control parameter calculating unit 21 is configured so that if the input values x1 (accelerator opening degree), x2 (engine speed), x3 (air temperature), x4 (altitude) are input to the control parameter calculating unit 21, the control parameter calculating unit 21 outputs the target torque control value “y” of the engine 24. Normally, this target torque control value “y” is directly sent by the switching unit 22 to the engine control unit 23. At this time, the actual output torque Tr of the engine becomes the target torque Tt.

Now then, if the vehicle 1 is used over a long time, due to aging of the engine 24, torque deviation occurs between the actual output torque Tr of the engine 24 and the target torque Tt. The torque deviation ΔTt (=Tt−Tr) between the actual output torque Tr and the target torque Tt of this engine 24 is calculated based on the output of the target torque calculating unit 20 and the detected value of the torque sensor 24a at the torque deviation calculating unit 26. If the torque deviation ΔTt becomes larger, due to the switching control unit 27, the switching unit 22 is switched so that the output value of the control parameter calculating unit 21 is input to the feedback correcting unit 25. At this time, at the feedback correcting unit 25, C·ΔTt (C is a small constant) is added to the target torque control value “y” output from the control parameter calculating unit 21 so that the torque deviation ΔTt becomes smaller, and the result of addition “y” (=y+C·ΔTt) is input to the engine control unit 23. Next, if the torque deviation ΔTt becomes an allowable value or less, the switching unit 22 is switched so that the output value of the control parameter calculating unit 21 is directly input to the engine control unit 23.

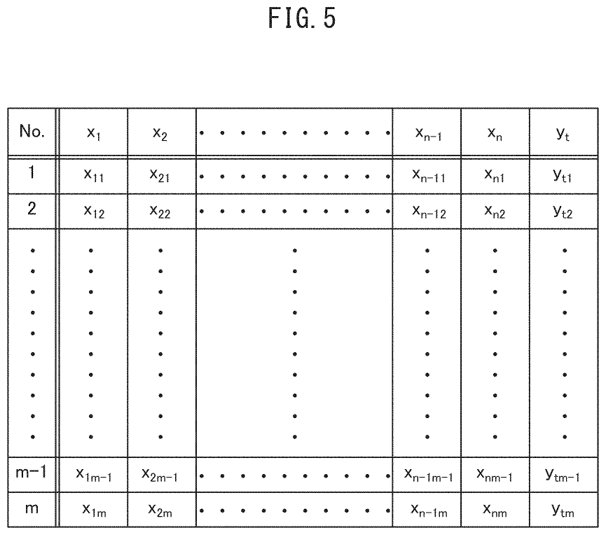

In this first example, normally, the input values x1, x2, x3, x4 when the torque deviation ΔTt becomes the allowable value or less and the target torque control value “y” which is output from the feedback correcting unit 25 (=y+C·ΔTt) when the torque deviation ΔTt becomes the allowable value or less are successively stored each time the torque deviation ΔTt becomes the allowable value or less. Due to this, the learning-use data sets such as shown in FIG. 5 are prepared. Note that, in this case, the target torque control value “y” which is output from the feedback correcting part 25 (=y+C·ΔTt) is stored as training data yt in the learning-use data sets. If the learning-use data sets such as shown in FIG. 5 are prepared, in an embodiment according to the present invention, learning of the weights of the neural network NN forming the control parameter calculating unit 21 is performed on the vehicle 1 or at the server 2 and a learned model outputting the target torque control value “y” is generated by the learned neural network NN.

At the time of learning the weights of the neural network NN, first, the input values x1, x2, x3, x4 of the No. 1 set in the learning-use data sets such as shown in FIG. 5 are input to the neural network NN such as shown in FIG. 4 and learning of the weights of the neural network NN is performed by the error backpropagation method so that the square error E (=½ (y−yt)²) of the output value “y” output from the neural network NN and the corresponding training data yt at that time becomes smaller. If the learning of the weights of the neural network NN based on the No. 1 data set ends, the input values x1, x2, x3, x4 of the No. 2 set are input to the neural network NN and learning of the weights of the neural network NN is performed by the error backpropagation method so that the square error E (=½ (y−yt)²) of the output value “y” output from the neural network NN and the corresponding training data yt at that time becomes smaller. After that, by the same technique, learning of the weights of the neural network NN is successively performed based on the corresponding data sets from the No. 3 to the No. “m” sets. If learning of the weights of the neural network NN based on all of the data sets from the No. 1 to the No. “m” sets is completed, the learned weights are used so that the weights of the neural network NN forming the control parameter calculating unit 21 are updated.

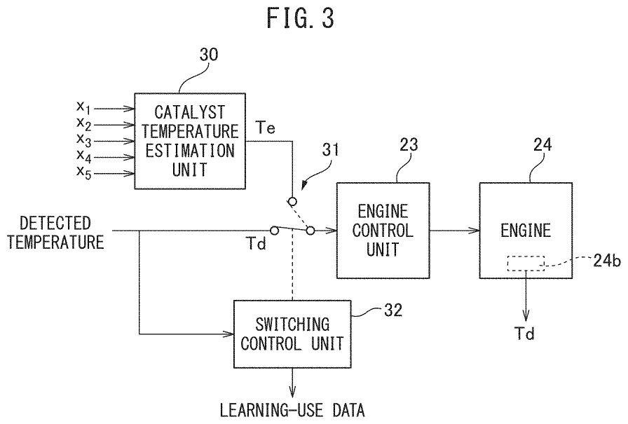

FIG. 3 shows a view of the functional configuration of a second example. If referring to FIG. 3, this second example is comprised of a catalyst temperature estimation unit 30 for estimating a temperature of a catalyst arranged in an engine exhaust passage, a switching unit 31, an engine control unit 23 for controlling an engine 24 of the vehicle 1, and a switching control unit 32. Note that, in the engine 24, a temperature sensor 24b for detecting the actual catalyst temperature Td is attached. A detection signal of this temperature sensor 24b is input by the switching unit 31 to the engine control unit 23. Based on the actual catalyst temperature Td detected by the temperature sensor 24b, for example, warmup operation control and other control of the engine 24 are performed.

On the other hand, in the second example, a catalyst temperature estimation unit 30 for when the temperature sensor 24b is malfunctioning is provided. This catalyst temperature estimation unit 30, for example, is comprised of a neural network NN such as shown in FIG. 4. This catalyst temperature estimation unit 30 is configured so that if the input values x1 (engine load rate), x2 (engine speed), x3 (air-fuel ratio), x4 (ignition timing), and x5 (HC or CO concentration in exhaust gas) are input to the catalyst temperature estimation unit 30, the catalyst temperature estimation unit 30 outputs an estimated value Te of the catalyst temperature. In the switching control unit 32, based on the detection value of the temperature sensor 24b, it is judged if the temperature sensor 24b is normal. When it is judged that the temperature sensor 24b is malfunctioning, the switching unit 31 is switched so that the output value of the catalyst temperature estimation unit 30 is input to the engine control unit 23. At this time, the estimated value Te of the catalyst temperature calculated by the catalyst temperature estimation unit 30 is input to the engine control unit 23, and control of the engine 24 is performed based on this estimated value Te of the catalyst temperature.

In the second example, when at the switching control unit 32 it is judged that the temperature sensor 24b is normal based on the detection value of the temperature sensor 24b, for example, periodically the input values x1, x2, x3, x4, x5 and the actual catalyst temperature Td detected by the temperature sensor 24b at that time are successively stored. Due to this, the learning-use data sets such as shown in FIG. 5 are prepared. Note that, in this case, the actual catalyst temperature Td detected by the temperature sensor 24b is stored in a learning-use data set as the training data yt. If the learning-use data sets such as shown in FIG. 5 are prepared, in an embodiment according to the present invention, learning of the weights of the neural network NN forming the catalyst temperature estimation unit 30 is performed on the vehicle 1 or at the server 2. Due to the learned neural network NN, a learned model outputting the estimated value Te of the catalyst temperature is generated.

At the time of learning the weights of the neural network NN, in this case as well, first, the input values x1, x2, x3, x4, x5 of the No. 1 set of the learning-use data sets such as shown in FIG. 5 are input to the neural network NN such as shown in FIG. 4. At that time, learning of the weights of the neural network NN is performed by the error backpropagation method so that the square error E (=½ (y−yt)²) of the output value “y” output from the neural network NN and the corresponding training data yt becomes smaller. If learning of the weights of the neural network NN based on the No. 1 data set ends, the input values x1, x2, x3, x4, x5 of the No. 2 set are input to the neural network NN. At that time, learning of the weights of the neural network NN is performed by the error backpropagation method so that the square error E (=½ (y−yt)²) of the output value “y” output from the neural network NN and the corresponding training data yt becomes smaller. After that, by a similar method, learning of the weights of the neural network NN is successively performed based on the corresponding data sets from the No. 3 to the No. “m” sets. If learning of the weights of the neural network NN based on all of the data sets from the No. 3 to No. “m” sets is completed, the weights of the neural network NN configuring the catalyst temperature estimation unit 30 are updated using the learned weights.

Now then, in an embodiment according to the present invention, the learning processing for preparing a learned model is repeatedly performed during operation of the vehicle 1 on the vehicle 1 or at the server 2. In this case, to precisely learn the weights of the neural network NN, a sufficient amount of the learning-use data is required for preparing the learning-use data sets such as shown in FIG. 5, and the learning-use data has to be successively continuously continued to be acquired in the interval from when the previous learning processing was performed to when the current learning processing is performed. Therefore, in an embodiment according to the present invention, the learning-use data is successively continuously continued to be acquired between the repeatedly performed learning processing and learning process until a sufficient amount of the learning-use data for preparing the learning-use data sets such as shown in FIG. 5 is acquired. In this case, in an embodiment according to the present invention, the learning-use data required for performing learning of the weights of the neural network NN is stored in the memory 6 of the electronic control unit 3 of the vehicle 1. Therefore, in an embodiment according to the present invention, the amount of the learning-use data successively stored in the memory 6, that is, the amount of storage of the learning-use data stored in the memory 6, gradually increases during operation of the vehicle 1.

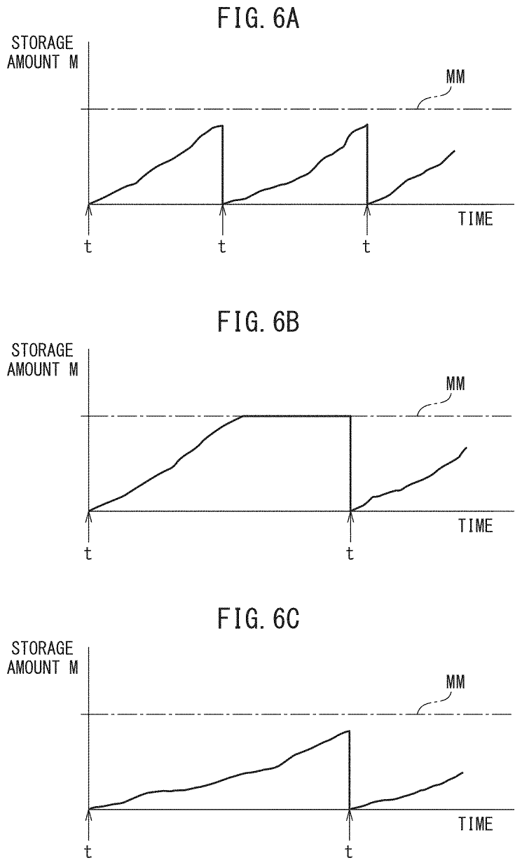

In this regard, electric power is required for performing learning of the weights of the neural network NN, therefore, if learning of the weights of the neural network NN is performed on the vehicle 1, the learning of the weights of the neural network NN is, for example, performed when the predetermined learning condition such as the an operating state with little amount of consumption of electric power stands. Therefore, the frequency of learning in the case where learning of the weights of the neural network NN is performed on the vehicle 1, that is, the frequency of onboard learning, is not constant, but fluctuates in accordance with the operating state of the vehicle 1 etc. FIG. 6A shows the changes in the amount of storage M of the learning-use data stored in the memory 6 when onboard learning is being performed by a relatively high frequency. Note that, in FIG. 6A, the time “t” shows when the onboard learning processing is performed. If onboard learning processing is performed, the learning-use data stored in the memory 6 is erased. Therefore, if onboard learning processing is performed, after that, the amount of storage M of the learning-use data, as shown in FIG. 6A, gradually increases along with the elapse of time. Then, if onboard learning is performed, the amount of storage M of the learning-use data becomes zero.

On the other hand, in FIG. 6A, MM shows the storage capacity able to be used for storage of the learning-use data in the storage capacity of the memory 6. If onboard learning is being performed, this storage capacity MM is made a capacity able to store the amount of the learning-use data necessary for preparing the learning-use data sets such as shown in FIG. 5. Now then, when onboard learning is being performed by a relatively high frequency, as shown in FIG. 6A, the time interval when onboard learning processing is executed is relatively short, therefore, in this case, as shown in FIG. 6A, the amount of storage M of the learning-use data stored in the memory 6 becomes the storage capacity MM or less and there is no liability of the storage capacity of the memory 6 being insufficient. As opposed to this, if the frequency of onboard learning becomes low, the time interval when onboard learning processing is executed becomes longer. As a result, if onboard learning processing is performed in this case, as shown in FIG. 6B, the amount of storage M of the learning-use data stored in the memory 6 will end up reaching the storage capacity MM before the onboard learning processing is performed.

If in this way the amount of storage M of the learning-use data reaches the storage capacity MM, the learning-use data which is acquired after that will be discarded without being stored in the memory 6. That is, in this case, the storage capacity of the memory 6 will become insufficient with respect to the learning-use data. If in this way the storage capacity of the memory 6 becomes insufficient with respect to the learning-use data, as will be understood from FIG. 6B, the learning-use data which is acquired after the amount of storage M of the learning-use data reaches the storage capacity MM and until the onboard learning processing is performed can no longer be used for onboard learning. In this regard, in learning processing, there are many cases where the data close to when the learning processing is performed has a particularly important effect on the learning results. Therefore, it is necessary to avoid a situation arising where the learning-use data, which is acquired after the amount of storage M of the learning-use data reaches the storage capacity MM and until the onboard learning processing is performed, can no longer be used for onboard learning.

Therefore, in an embodiment according to the present invention, when learning of the weights of the neural network NN is performed on the vehicle 1, that is, when onboard learning is performed, if the frequency of learning of the weights of the neural network NN in the vehicle becomes lower, the amount of storage of the learning-use data successively stored per unit time in the memory 6, that is, the learning-use data storage unit, or the learning-use data which finishes being stored in the learning-use data storage unit is made to decrease. If in this way making the amount of storage of the learning-use data successively stored per unit time in the learning-use data storage part or the learning-use data which finishes being stored in the learning-use data storage unit decrease, as shown in FIG. 6C, the amount of storage M of the learning-use data gradually increases. Therefore, the amount of storage M of the learning-use data no longer exceeds the storage capacity MM and all of the learning-use data acquired before the learning processing is performed becomes able to be used for learning.

On the other hand, in the case of preparing a learned model at the server 2, the learning-use data stored at the memory 6 is transmitted to the server 2. In this case, it is possible to transmit the amount of the learning-use data required for preparing the learning-use data sets such as shown in FIG. 5 to the server 2 at one time and possible to divide it into small parts and transmit it to the server 2 at little at a time. In this case, in an embodiment according to the present invention, the amount of the learning-use data required for preparing the learning-use data sets such as shown in FIG. 5 is divided into small parts and is transmitted to the server 2 at little at a time. In this case, the storage capacity MM with respect to the amount of storage M of the learning-use data is made a smaller capacity compared with the storage capacity MM in the case where onboard learning is performed. Even if in this way the storage capacity MM with respect to the amount of storage M of the learning-use data is made smaller, in the case of preparing a learned model at the server 2, the amount of storage M of the learning-use data changes as shown in FIG. 6A and FIG. 6B in the same way as the case where onboard learning is being performed. However, in this case, the time “t” in FIG. 6A and FIG. 6B shows the time of transmission of the learning-use data to the server 2.

That is, there are limits to the amount of wireless communication and communication speed to the server 2. The learning-use data is transmitted to the server 2 when a predetermined transmission condition stands. If the learning-use data stored in the memory 6 is transmitted to the server 2, the learning-use data stored in the memory 6 is erased. Therefore, in this case as well, if the frequency of transmission of the learning-use data to the server 2 is high, as shown in FIG. 6A, the interval between the repeatedly performed transmission processing and transmission processing is short, so even if the learning-use data successively continuously continues to be acquired during that, the amount of the learning-use data stored in the memory 6 does not become that great and there is no liability of the storage capacity MM of the memory 6 becoming insufficient. As opposed to this, if the frequency of transmission of the learning-use data to the server 2 becomes lower, as shown in FIG. 6B, the interval between the repeatedly performed transmission processing and transmission processing becomes longer, so if the learning-use data successively continuously continues to be acquired during that, the amount of the learning-use data to be stored in the memory 6 becomes greater and the liability appears of the storage capacity MM of the memory 6 becoming insufficient.

Therefore, in an embodiment according to the present invention, in the case of transmitting the learning-use data stored in the memory 6 for preparing a learned model at the server 2 to the server 2, if the frequency of transmission of the learning-use data to the server 2 becomes lower, the amount of storage per unit time of the learning-use data successively stored in the memory 6, that is, the learning-use data storage unit, or the learning-use data which finishes being stored in the learning-use data storage unit is made to decrease. In this way, if making the amount of storage per unit time of the learning-use data successively stored in the learning-use data storage unit or the learning-use data which finishes being stored in the learning-use data storage unit decrease, as shown in FIG. 6C, the amount of storage M of the learning-use data gradually increases and the amount of storage M of the learning-use data no longer exceeds the storage capacity. Therefore, in this case as well, it becomes possible to use all of the learning-use data acquired before transmission for the learning.

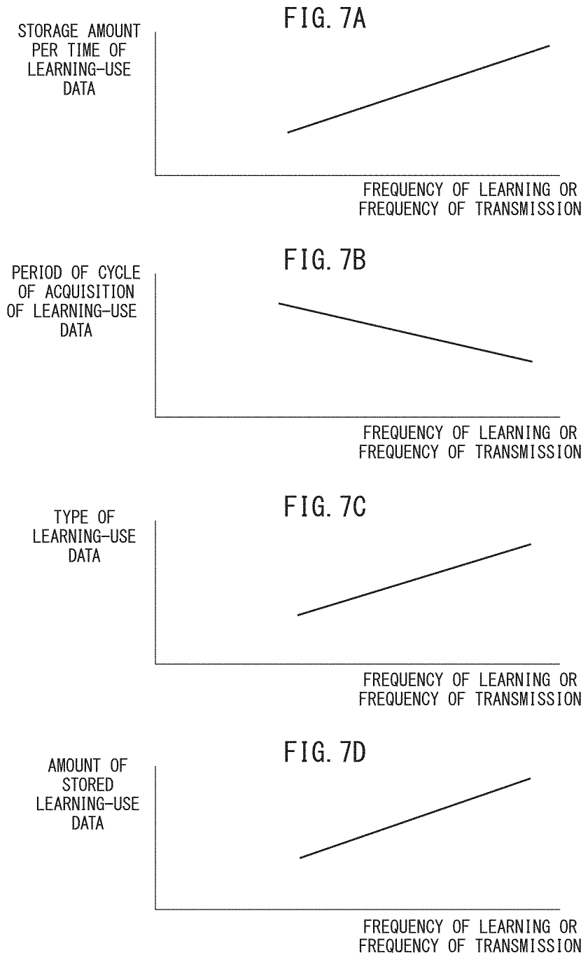

Next, this will be explained a bit more specifically while referring to FIG. 7A to FIG. 7D. Note that, the abscissa of FIG. 7A to FIG. 7D shows the frequency of learning of the weights of the neural network NN performed on the vehicle 1, that is, the frequency of onboard learning, or the frequency of transmission of the learning-use data stored in the memory 6 to the server 2 for performing learning of the weights of the neural network NN at the server 2. Note that, hereinafter, these frequency of onboard learning or frequency of transmission to the server 2 will be simply referred to as the frequency of learning or the frequency of transmission.

As explained above, in an embodiment according to the present invention, when performing learning of the weights of the neural network NN on the vehicle 1, if the frequency of learning of the weights of the neural network NN becomes lower, the amount of storage per unit time of the learning-use data successively stored in the learning-use data storage part is made to decrease. Furthermore, when sending the learning-use data stored in the memory 6 to the server 2 to perform learning of the weights of the neural network NN at the server 2, if the frequency of transmission of the learning-use data to the server 2 becomes lower, the amount of storage per unit time of the learning-use data successively stored in the learning-use data storage part is made to decrease. In this case, in an embodiment according to the present invention, as shown in FIG. 7A, the amount of storage per unit time of the learning-use data successively stored in the learning-use data storage part is made to decrease the lower the frequency of learning or the frequency of transmission.

In this case, in one embodiment according to the present invention, by changing the learning-use data which is acquired, the amount of storage per unit time of the learning-use data successively stored in the learning-use data storage part is made to decrease. In this case, in this embodiment, sometimes the period of the cycle of acquisition of the learning-use data is changed so as to change the learning-use data which is acquired and sometimes the types of the learning-use data which is acquired is changed so as to change the learning-use data which is acquired. When changing the period of the cycle of acquisition of the learning-use data to change the learning-use data which is acquired, by increasing the period of the cycle of acquisition of the learning-use data, the amount of storage per unit time of the learning-use data successively stored in the learning-use data storage part is made to decrease. In this case, for example, as shown in FIG. 7B, the lower the frequency of learning or the frequency of transmission becomes, the more the period of the cycle of acquisition of the learning-use data is made to increase. If the period of the cycle of acquisition of the learning-use data is made to increase, for example, in the learning-use data set shown in FIG. 5, the time interval after acquiring the No. k data set until acquiring the No. k+1 data set becomes longer, therefore, the amount of storage M of the learning-use data slowly increases.

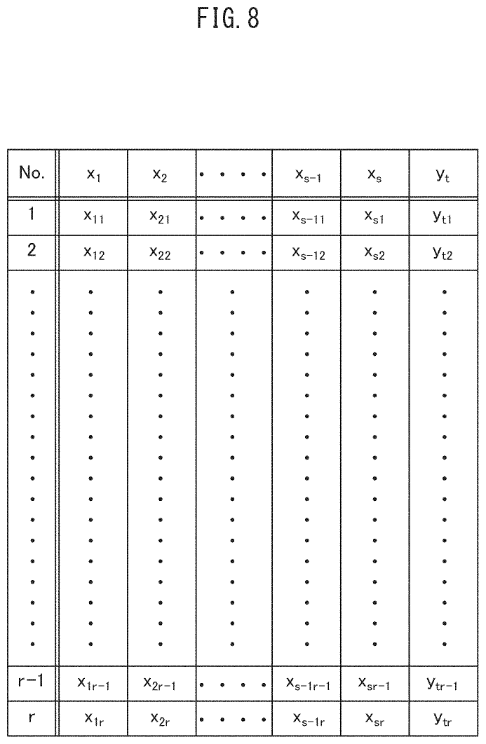

On the other hand, when changing the types of the learning-use data which are acquired to change the learning-use data which is acquired, the amount of storage of the learning-use data which is successively stored in the learning-use data storage unit per unit time is made to decrease by decreasing the types of the learning-use data which are acquired. In this case, for example, as shown in FIG. 7C, the lower the frequency of learning or the frequency of transmission, the more the types of the learning-use data is made to decrease. If the types of the learning-use data is made to decrease, for example, the input values x₁, x₂ . . . xₙ₋₁, xₙ in the learning-use data sets shown in FIG. 5 are changed to the input values x₁, x₂ . . . xₛ₋₁, xₛ in the learning-use data sets shown in FIG. 8, that is, the number of the input values is made to decrease from “n” number to “s” number. Therefore, the amount of the learning-use data which is acquired each time becomes smaller, so the amount of storage M of the learning-use data slowly increases. However, in this case, the number of data sets prepared before performing the learning processing, as shown in FIG. 8, is increased from “m” number to “r” number. If giving a specific example, in the first example shown in FIG. 2, for example, by deleting altitude from the input values, the types of the learning-use data which are acquired are decreased. In the second example shown in FIG. 3, for example, by deleting the HC or CO concentration in the exhaust gas from the input values, the types of the learning-use data which are acquired are decreased.

On the other hand, as explained above, in an embodiment according to the present invention, in the case where learning of the weights of the neural network NN is performed on the vehicle 1, if the frequency of learning of the weights of the neural network NN becomes lower, the learning-use data which finishes being stored in the learning-use data storage unit is made to decrease. Further, if transmitting the learning-use data stored in the memory 6 to the server 2 for performing learning of the weights of the neural network NN at the server 2, if the frequency of transmission of the learning-use data to the server 2 becomes lower, the learning-use data which finishes being stored in the learning-use data storage unit is made to decrease. In this case, in an embodiment according to the present invention, as shown in FIG. 7D, the learning-use data which finishes being stored in the learning-use data storage unit is made to decrease the lower the frequency of learning or the frequency of transmission becomes.

In this case, in one embodiment according to the present invention, by processing the learning-use data which finishes being stored in the learning-use data storage unit, the learning-use data which finishes being stored in the learning-use data storage unit is made to decrease. In this case, by thinning part of the data sets from the data sets which finish being stored in the learning-use data storage unit, the learning-use data which finishes being stored in the learning-use data storage unit is made to decrease or, alternatively, by thinning the data relating to part of the input values from the data sets which finish being stored in the learning-use data storage unit, the learning-use data which finishes being stored in the learning-use data storage unit is made to decrease.

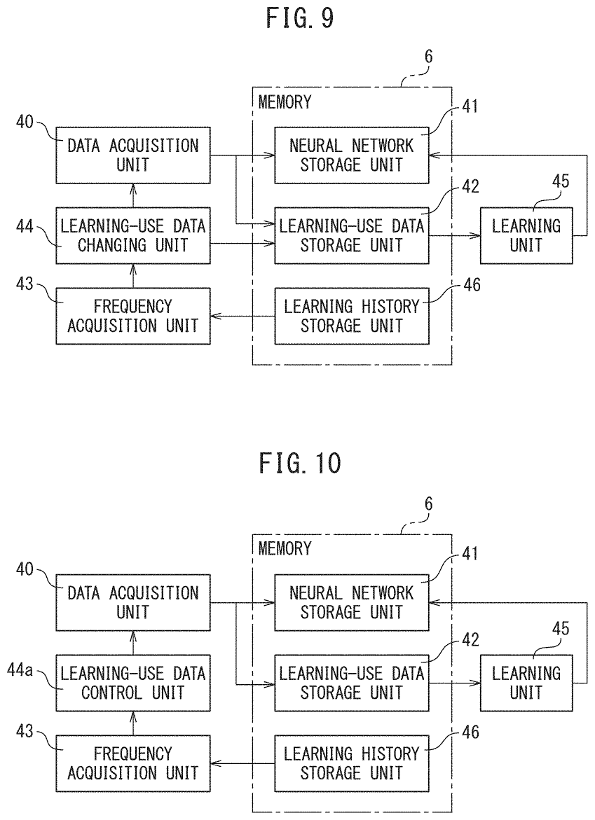

FIG. 9 shows a view of the functional configuration of one embodiment of the vehicle-mounted processing device according to the present invention in the case where learning of the weights of the neural network NN is performed on the vehicle 1, that is, in the case where onboard learning is performed. Note that, the functions shown in FIG. 9 are performed in the electronic control unit 3 mounted in the vehicle 1. Further, in FIG. 9, the memory 6 of the electronic control unit 3 is shown. If referring to FIG. 9, in this embodiment, the vehicle-mounted processing device is provided with a data acquisition unit 40 acquiring data relating to operation of the vehicle 1, a neural network storage unit 41 storing a neural network NN outputting output values relating to operational control of the vehicle if data acquired at the data acquisition part 40 is input, a learning-use data storage unit 42 storing the learning-use data of the weights of the neural network NN, a frequency acquisition unit 43 acquiring the frequency of learning of the weights of the neural network NN in the vehicle, and a learning-use data changing unit 44.

In this embodiment, based on the frequency of learning of the weights of the neural network NN in the vehicle 1 acquired by the frequency acquisition unit 43, if the frequency of learning of the weights of the neural network NN in the vehicle 1 becomes lower, the amount of storage per unit time of the learning-use data successively stored in the learning-use data storage unit 42 or the amount of the learning-use data which finishes being stored in the learning-use data storage unit 42 is made to decrease by the learning-use data changing unit 44. Furthermore, in this embodiment, the vehicle-mounted processing device is provided with a learning unit 45 performing learning of the weights of the neural network NN and a learning history storage 46 storing the learning history of the weights of the neural network NN on the vehicle 1. In the frequency acquisition unit 43, the frequency of learning is found from the learning history stored in the learning history storage unit 46.

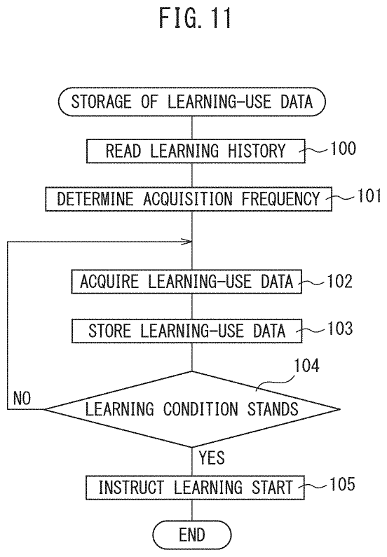

FIG. 10 shows a view of the functional configuration of one example of the vehicle-mounted processing device shown in FIG. 9. In the example shown in FIG. 10, as the learning-use data changing unit 44 shown in FIG. 9, a learning-use data control unit 44a for controlling the learning-use data which the data acquisition unit 40 acquires is used. In FIG. 11 to FIG. 14, various processing routines executed in the view of the functional configuration shown in this FIG. 10 are shown. Therefore, next, these processing routines will be explained in order.

FIG. 11 shows a storage routine of learning-use data when lowering the frequency of acquisition of the learning-use data which is acquired at the data acquisition unit 40 the lower the frequency of learning becomes in the case where onboard learning is performed. This routine is suitable for the first example shown in FIG. 2. That is, as explained before, in the first example, normally, the input values x1, x2, x3, x4 when the torque deviation ΔTt becomes an allowable value or less and the target torque control value “y” which is output from the feedback correcting part 25 (=y+C·ΔTt) when the torque deviation ΔTt becomes the allowable value or less are successively stored each time the torque deviation ΔTt becomes the allowable value or less. That is, in this first example, normally, the learning-use data is successively stored each time the torque deviation ΔTt becomes the allowable value or less. In this case, in the example shown in FIG. 11, when the frequency of learning becomes low, the learning-use data is not necessarily stored even if the torque deviation ΔTt becomes the allowable value or less. The learning-use data is stored by the determined frequency of acquisition of the learning-use data.

If referring to FIG. 11, at step 100, the learning history of the onboard learning stored at the learning history storage unit 46 is read. Next, at step 101, the frequency of acquisition of the learning-use data is determined from the learning history of the onboard learning. In this case, the lower the frequency of learning of the onboard learning, the lower the frequency of acquisition of the learning-use data which is acquired at the data acquisition unit 40 becomes. Next, at step 102, the learning-use data is acquired by the frequency of acquisition determined at step 101. Next, at step 103, the learning-use data which is acquired is stored in the learning-use data storage unit 42. Next, at step 104, it is judged if a learning condition stands. When it is judged that the learning condition does not stand, the routine returns to step 102 where the action of acquisition of the learning-use data is continued. On the other hand, when at step 104 it is judged that the learning condition stands, the routine proceeds to step 105 where a learning start instruction is issued.

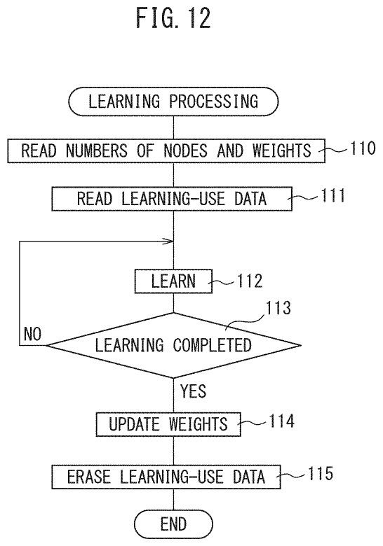

If the learning start instruction is issued, at the learning unit 45, the learning processing routine shown in FIG. 12 is executed. If referring to FIG. 12, at step 110, the numbers of nodes and weights of the input layer, hidden layers, and output layer of the neural network NN are read. Based on these numbers of nodes, the neural network NN such as shown in FIG. 4 is prepared. Next, at step 111, the learning-use data stored at the learning-use data storage unit 42, that is, the learning-use data sets such as shown in FIG. 5, is read. Next, at step 112, learning of the weights of the neural network NN is performed using the above-mentioned error backpropagation method based on this learning-use data sets. Next, at step 113, it is judged if learning of the weights of the neural network NN has finished. When it is judged that learning of the weights of the neural network NN has not finished, the routine returns to step 112 where the learning of the weights of the neural network is continued. On the other hand, when at step 113 it is judged that learning of the weights of the neural network NN has finished, the routine proceeds to step 114 where the weights of the neural network NN are updated. Next, at step 115, the learning-use data stored at the learning-use data storage unit 42 is erased. If the learning-use data is erased, the storage routine of the learning-use data shown in FIG. 11 is again executed.

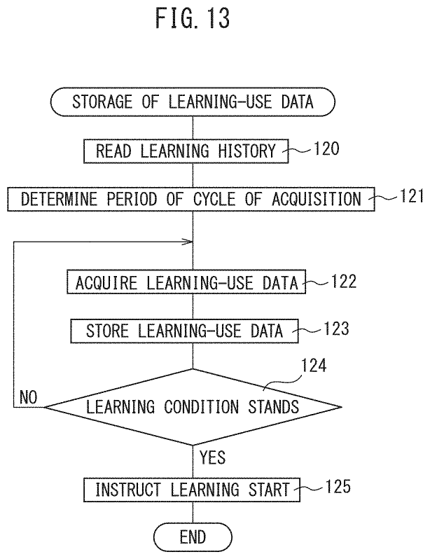

FIG. 13 shows a storage routine of the learning-use data when making the period of the cycle of acquisition of the learning-use data which is acquired at the data acquisition unit 40 increase the lower the frequency of learning in the case where onboard learning is performed, that is, a storage routine of the learning-use data for working the embodiment shown in FIG. 7B. This routine is suitable for the second example shown in FIG. 3. That is, as explained before, in the second example, the input values x1, x2, x3, x4, x5 and the actual catalyst temperature Td detected by the temperature sensor 24b at that time are periodically successively stored. That is, in the second example, the learning-use data is periodically successively stored. In this case, in the example shown in FIG. 13, when the frequency of learning becomes lower, the period of the cycle of acquisition of the learning-use data is increased and the period of the cycle at which the learning-use data is stored is made longer.

If referring to FIG. 13, at step 120, the learning history of onboard learning stored at the learning history storage unit 46 is read. Next, at step 121, the period of the cycle of acquisition of the learning-use data is determined from the learning history of onboard learning. In this case, the lower the frequency of learning of onboard learning, the longer the period of the cycle of acquisition of the learning-use data which is acquired at the data acquisition unit 40. Next, at step 122, the learning-use data is acquired by the period of the cycle of acquisition determined at step 121. Next, at step 123, the learning-use data which is acquired is stored in the learning-use data storage unit 42. Next, at step 124, it is judged if a learning condition stands. When it is judged that the learning condition does not stand, the routine returns to step 122 where the action of acquisition of the learning-use data is continued. On the other hand, when at step 124 it is judged that the learning condition stands, the routine proceeds to step 125 where a learning start instruction is issued. If the learning start instruction is issued, at the learning unit 45, the learning processing routine shown in FIG. 12 is executed.

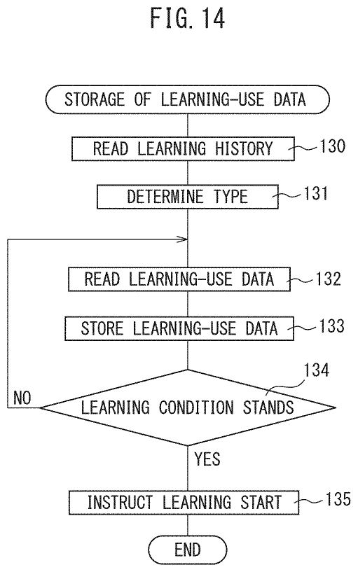

FIG. 14 shows a storage routine of the learning-use data when making the types of the learning-use data which are acquired at the data acquisition unit 40 decrease the lower the frequency of learning in the case where onboard learning is performed, that is, a storage routine of the learning-use data for working the embodiment shown in FIG. 7C. In this case, in the first example shown in FIG. 2, if the frequency of learning becomes lower, one or more of the input values among the input values x1, x2, x3, x4 are no longer acquired and stored, while in the second example shown in FIG. 3, if the frequency of learning becomes lower, one or more of the input values among the input values x1, x2, x3, x4, x5 are no longer acquired and stored.

If referring to FIG. 14, at step 130, the learning history of onboard learning stored in the learning history storage unit 46 is read. Next, at step 131, the types to be acquired are determined from the learning history of the onboard learning. In this case, the lower the frequency of learning of the onboard learning, the more the types of the learning-use data which are acquired at the data acquisition unit 40 is made to decrease. Next, at step 132, the learning-use data which was determined at step 131 to be acquired is acquired. Next, at step 133, the learning-use data which is acquired is stored in the learning-use data storage unit 42. Next, at step 134, it is judged if a learning condition stands. When it is judged that the learning condition does not stand, the routine returns to step 132 where the action of acquisition of the learning-use data is continued. On the other hand, when at step 134 it is judged that the learning condition stands, the routine proceeds to step 135 where a learning start instruction is issued. If the learning start instruction is issued, at the learning unit 45, the learning processing routine shown in FIG. 12 is executed.

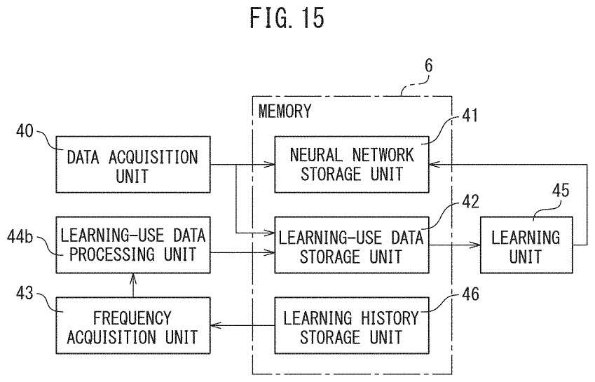

FIG. 15 shows a view of the functional configuration of another example of the vehicle-mounted processing device shown in FIG. 9. In the example shown in FIG. 15, as the learning-use data changing unit 44 shown in FIG. 9, a learning-use data processing unit 44b for processing the learning-use data stored in the learning-use data storage unit 42 is used. In this case, in this example, by processing the learning-use data finished being stored in the learning-use data storage unit 42, as shown in FIG. 7D, the lower the frequency of learning, the more the amount of the learning-use data which finishes being stored in the learning-use data storage unit 42 is made to decrease. Note that, in this case, as explained before, by thinning part of the data sets from the data sets which finish being stored in the learning-use data storage unit 42, the amount of the learning-use data which finishes being stored in the learning-use data storage unit 42 is made to decrease or, alternatively, by thinning the data relating to part of the input values from the data sets which finish being stored in the learning-use data storage unit 42, the amount of the learning-use data which finishes being stored in the learning-use data storage unit 42 is made to decrease.

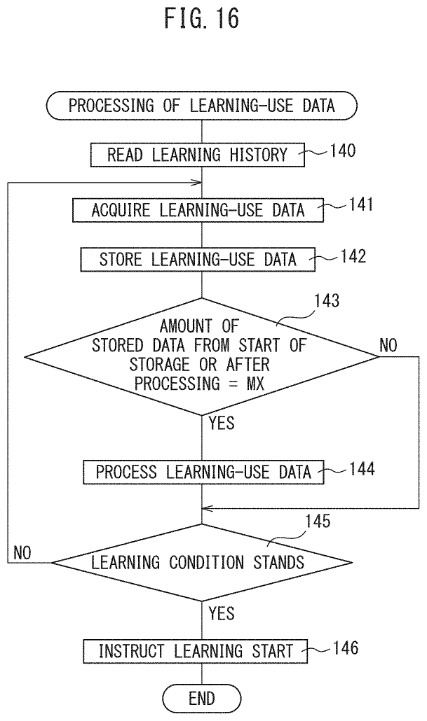

In FIG. 16, a processing routine of the learning-use data performed at the view of the functional configuration shown in FIG. 15, that is, a processing routine of the learning-use data when making the amount of the learning-use data which finishes being stored in the learning-use data storage unit 42 decrease the lower the frequency of learning in the case where onboard learning is performed, is shown. If referring to FIG. 16, at step 140, the learning history of onboard learning stored in the learning history storage unit 46 is read. Next, at step 141, the learning-use data is acquired. Next, at step 142, the learning-use data which is acquired is stored in the learning-use data storage unit 42. Next, at step 143, it is judged if the amount of stored data from the start of storing the learning-use data in the learning-use data storage unit 42 reaches a preset reference amount MX (<storage capacity MM), or, at the time of after the learning-use data is processed, it is judged if the amount of stored data after processing the learning-use data reaches the preset reference amount MX. When it is judged that the amount of stored data from the start of storing the learning-use data in the learning-use data storage unit 42 or the amount of stored data after processing the learning-use data does not reach the reference amount MX, the routine jumps to step 145.

As opposed to this, when it is judged that the amount of stored data from the start of storing the learning-use data in the learning-use data storage unit 42 or the amount of stored data after processing the learning-use data reaches the reference amount MX, the routine proceeds to step 144 where the processing of the learning-use data finished being stored in the learning-use data storage unit 42 is performed. At this time, the lower the frequency of learning becomes, the more the amount of the learning-use data which finishes being stored in the learning-use data storage unit 42 is made to decrease. In this case, as explained before, by thinning part of the data sets from the data sets which finish being stored in the learning-use data storage unit 42, the amount of the learning-use data which finishes being stored in the learning-use data storage unit 42 is made to decrease or, alternatively, by thinning the data relating to part of the input values from the data sets which finish being stored in the learning-use data storage unit 42, the amount of the learning-use data which finishes being stored in the learning-use data storage unit 42 is made to decrease. Next the routine proceeds to step 145. At step 145, it is judged if a learning condition stands. When it is judged that the learning condition does not stand, the routine returns to step 141 where the action of acquisition of the learning-use data is continued. On the other hand, when at step 145 it is judged that the learning condition stands, the routine proceeds to step 146 where a learning start instruction is issued. If the learning start instruction is issued, at the learning unit 45, the learning processing routine shown in FIG. 12 is executed.

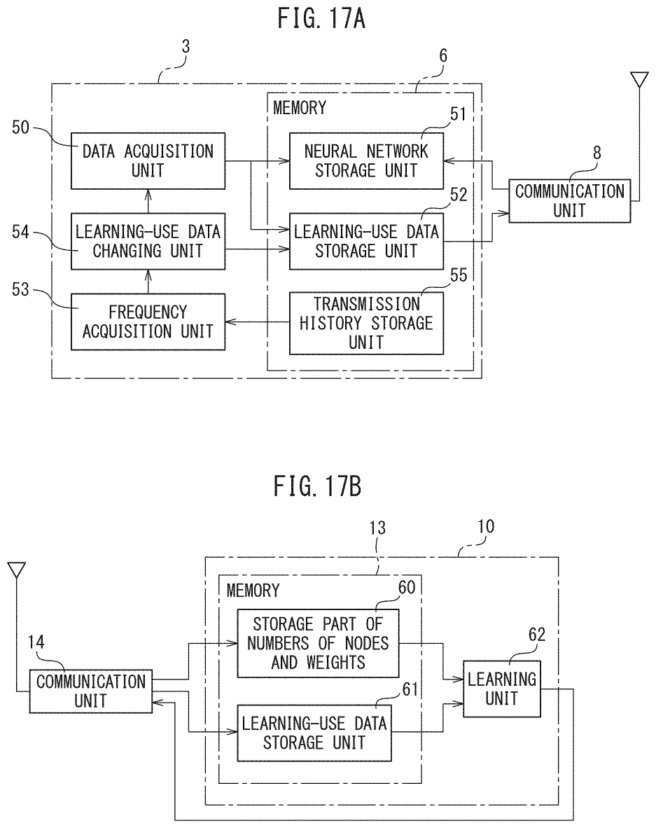

FIG. 17A shows a view of the functional configuration of one example of a vehicle-mounted processing device according to the present invention in the case of transmitting the learning-use data stored in the memory 6 of the vehicle 1 to the server 2 for performing learning of the weights of the neural network NN at the server 2, while FIG. 17B shows a view of the functional configuration of the server 2. Note that, in FIG. 17A, the electronic control unit 3 mounted in the vehicle 1, the memory 6, and the communication unit 8 are shown. In FIG. 17B, the electronic control unit 10, the memory 13, and the communication part 14 which are set in the server 2 are shown. First, if referring to FIG. 17A, in this embodiment, the vehicle-mounted processing device is provided with a data acquisition unit 50 acquiring data relating to operation of the vehicle 1, a neural network storage unit 51 storing a neural network NN outputting output values relating to operational control of the vehicle if the data acquired by the data acquisition unit 50 is input, a learning-use data storage unit 52 storing the learning-use data of the weights of the neural network NN, a frequency acquisition unit 53 acquiring a frequency of transmission of the learning-use data to the server 2, and a learning-use data changing unit 54. The learning-use data stored in the learning-use data storage unit 52 is transmitted to the server 2 by the communication unit 8.

In this embodiment, based on the frequency of transmission of the learning-use data to the server 2 acquired by the frequency acquisition unit 53, if the frequency of transmission of the learning-use data to the server 2 becomes lower, the amount of storage per unit time of the learning-use data successively stored in the learning-use data storage unit 52 or the amount of the learning-use data which finishes being stored in the learning-use data storage unit 52 is made to decrease by the learning-use data changing unit 54. Furthermore, in this embodiment, the vehicle-mounted processing device is provided with a transmission history storage unit 55 storing the transmission history of the learning-use data to the server 2. At the frequency acquisition unit 53, the frequency of transmission is found from the transmission history stored in the transmission history storage unit 55.

On the other hand, if referring to FIG. 17B, in this embodiment, the server 2 is provided with a node number and weight storage unit 60 storing the numbers of nodes and weights of the neural network NN, a learning-use data storage unit 61 storing the learning-use data of the weights of the neural network NN, and a learning unit 62 performing learning of the weights of the neural network NN. The learning-use data transmitted from the vehicle 1 is received by the communication unit 14.

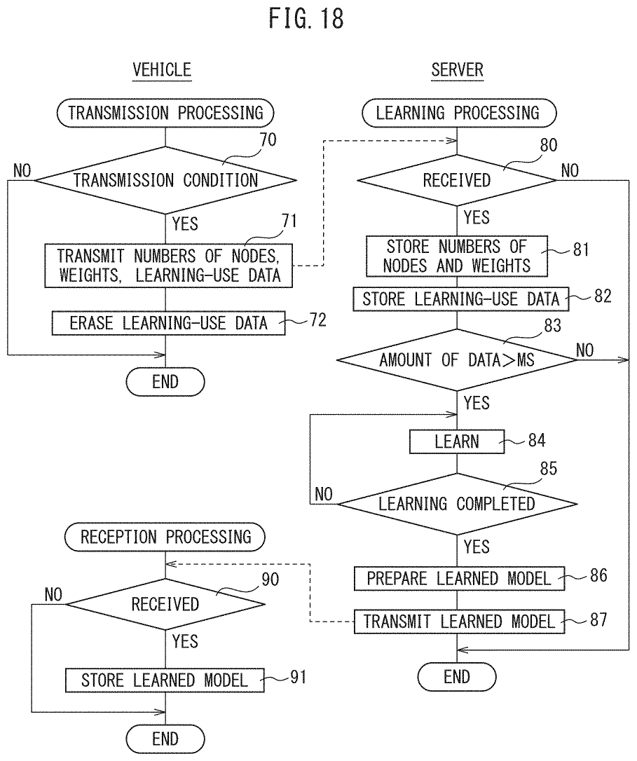

FIG. 18 shows all together the various processing routines of the transmission processing and reception processing performed at the vehicle 1 and the learning processing performed at the server 2. First, if referring to the transmission processing routine performed at the vehicle 1, at step 70, it is judged if a condition for transmission of the learning-use data from the vehicle 1 to the server 2 stands. When it is judged that the transmission condition stands, the routine proceeds to step 71 where the numbers of nodes and weights of the neural network NN and the learning-use data stored at the learning-use data storage unit 52 are transmitted to the server 2. Next, at step 72, the learning-use data stored at the learning-use data storage unit 52 is erased.

Next, If referring to the learning processing routine performed at the server 2, at step 80, it is judged if the numbers of nodes and weights of the neural network NN and the learning-use data have been received from the vehicle 1. When it is judged that the numbers of nodes and weights of the neural network NN and the learning-use data have been received, the routine proceeds to step 81 where the numbers of nodes and weights of the input layer, hidden layers, and output layer of the neural network NN are stored in the node number and weight storage unit 60. Based on these numbers of nodes, the neural network NN such as shown in FIG. 4 is prepared. Next, at step 82, the received learning-use data is stored in the learning-use data storage unit 61. Next, at step 83, it is judged if the amount of the learning-use data stored in the learning-use data storage unit 61 exceeds a preset amount MS sufficient for performing learning. When it is judged that the amount of the learning-use data stored in the learning-use data storage unit 61 exceeds the preset amount MS, the routine proceeds to step 84.

At step 84, the above-mentioned error backpropagation method is used to perform learning of the weights of the neural network NN based on the learning-use data stored at the learning-use data storage unit 42. Next, at step 85, it is judged if the learning of the weights of the neural network NN has finished. When it is judged that learning of the weights of the neural network NN has not finished, the routine returns to step 84 where the learning of weights of the neural network is continued. On the other hand, when at step 85 it is judged that learning of the weights of the neural network NN has finished, the routine proceeds to step 86 where the weights of the neural network NN are updated and a learned model is prepared by the neural network NN with the updated weights. Next, at step 87, the prepared learned model is transmitted by the communication unit 14 to the vehicle 1.

Next, if referring to the reception processing performed at the vehicle 1, at step 90, it is judged if the learned model has been received from the server 2. When it is judged that the learned model has been received from the server 2, the routine proceeds to step 91 where the learned model is stored in the neural network storage unit 51. If the learned model is stored in the neural network storage unit 51, this learned model is used to perform the operational control of the vehicle 1. For example, in the above-mentioned first example, using this learned model, the target torque control value “y” is found, while in the above-mentioned second example, using this learned model, the estimated value Te of the catalyst temperature is found.

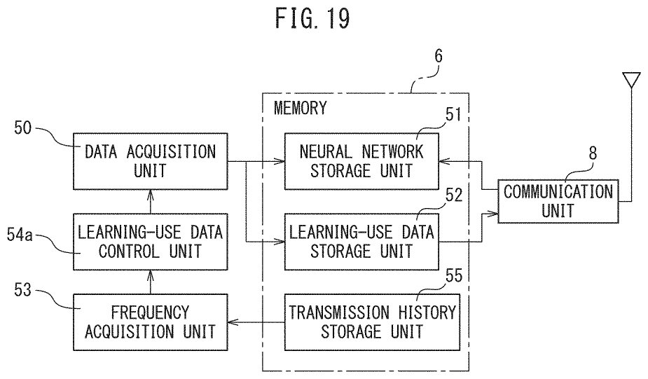

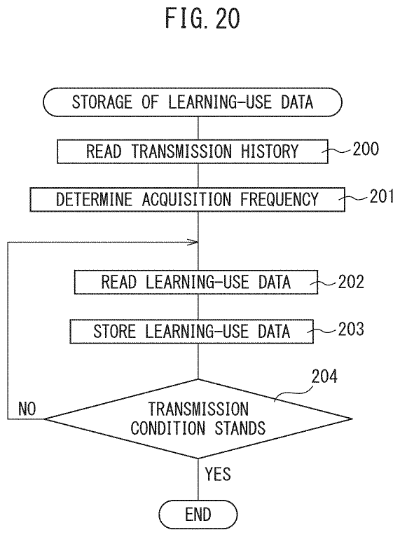

FIG. 19 shows a view of the functional configuration of one example of the vehicle-mounted processing device shown in FIG. 17A. In the example shown in FIG. 19, as the learning-use data changing unit 54 shown in FIG. 17A, a learning-use data control unit 54a for controlling the learning-use data which the data acquisition unit 50 acquires is used. In FIG. 20 to FIG. 22, the various processing routines performed in the view of the functional configuration shown in FIG. 19 are shown. Therefore, next, these processing routines will be successively explained.

FIG. 20 shows a storage routine of the learning-use data when lowering the frequency of acquisition of the learning-use data which is acquired at the data acquisition unit 50 the lower the frequency of transmission in the case of transmitting the learning-use data to the server 2 for performing learning of the weights of the neural network NN at the server 2. This routine is suitable for the first example shown in FIG. 2. That is, as explained before, in the first example, normally, the input values x1, x2, x3, x4 when the torque deviation ΔTt becomes the allowable value or less and the target torque control value “y” which is output from the feedback correcting part 25 (=y+C·ΔTt) when the torque deviation ΔTt becomes the allowable value or less are successively stored each time the torque deviation ΔTt becomes the allowable value or less. That is, in this first example, normally the learning-use data is successively stored each time the torque deviation ΔTt becomes the allowable value or less. In this case, in the example shown in FIG. 20, when the frequency of transmission becomes low, the learning-use data is not necessarily stored even if the torque deviation ΔTt becomes the allowable value or less. The learning-use data is stored by the determined frequency of acquisition of the learning-use data.

If referring to FIG. 20, at step 200, the transmission history of the learning-use data to the server 2 stored at the transmission history storage unit 55 is read. Next, at step 201, the frequency of acquisition of the learning-use data is determined from the transmission history of the learning-use data to the server 2. In this case, the lower the frequency of transmission of the learning-use data to the server 2, the lower the frequency of acquisition of the learning-use data which is acquired at the data acquisition unit 50. Next, at step 202, the learning-use data is acquired by the frequency of acquisition determined at step 201. Next, at step 203, the learning-use data which is acquired is stored at the learning-use data storage unit 52. Next, at step 204, it is judged if a transmission condition stands. When it is judged that the transmission condition does not stand, the routine returns to step 202 where the action of acquisition of the learning-use data is continued. On the other hand, when at step 204 it is judged that the transmission condition stands, the processing cycle is ended. At this time, as will be understood from the transmission processing routine performed at the vehicle 1 of FIG. 18, the numbers of nodes and weights of the neural network NN and the learning-use data stored at the learning-use data storage unit 52 are transmitted to the server 2.

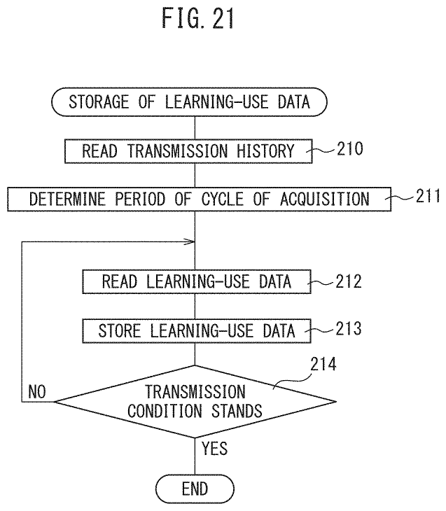

FIG. 21 shows a storage routine of learning-use data when making a period of the cycle of acquisition of learning-use data which is acquired at the data acquisition unit 50 increase the lower the frequency of transmission in the case of transmitting learning-use data to the server 2 for learning of the weights of the neural network NN at the server 2, that is, a storage routine of learning-use data for working the embodiment shown in FIG. 7B. This routine is suitable for the second example shown in FIG. 3. That is, as explained before, in the second example, the input values x1, x2, x3, x4, x5 and the actual catalyst temperature Td detected by the temperature sensor 24b at that time are periodically successively stored. That is, in this second example, the learning-use data is periodically successively stored. In this case, in the example shown in FIG. 21, when the frequency of transmission becomes lower, the period of the cycle of acquisition of the learning-use data is increased and the period of the cycle at which the learning-use data is stored is made longer.

If referring to FIG. 21, at step 210, the transmission history of the learning-use data to the server 2 stored at the transmission history storage unit 55 is read. Next, at step 211, the period of the cycle of acquisition of the learning-use data is determined from the transmission history of the learning-use data to the server 2. In this case, the lower the frequency of transmission of the learning-use data to the server 2, the longer the period of the cycle of acquisition of the learning-use data which is acquired at the data acquisition unit 40 is made. Next, at step 212, the learning-use data is acquired at the period of the cycle of acquisition determined at step 211. Next, at step 213, the learning-use data which is acquired is stored in the learning-use data storage unit 52. Next, at step 214, it is judged if a transmission condition stands. When it is judged that the transmission condition does not stand, the routine returns to step 212 where the action of acquisition of the learning-use data is continued. On the other hand, when at step 214 it is judged that the transmission condition stands, the processing cycle is ended. At this time, as will be understood from the transmission processing routine performed at the vehicle 1 of FIG. 18, the numbers of nodes and weights of the neural network NN and the learning-use data stored at the learning-use data storage unit 52 are transmitted to the server 2.

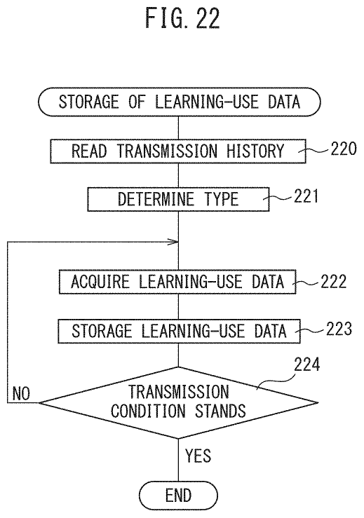

FIG. 22 shows a storage routine of the learning-use data when making the types of the learning-use data which is acquired at the data acquisition unit 50 decrease the lower the frequency of transmission in the case of transmitting the learning-use data to the server 2 for performing the learning of the weights of the neural network NN at the server 2, that is, a storage routine of the learning-use data for working the embodiment shown in FIG. 7C. In this case, in the first example shown in FIG. 2, if the frequency of learning becomes lower, one or more input values among the input values x1, x2, x3, x4 are no longer be acquired and stored. In the second example shown in FIG. 3, if the frequency of learning becomes lower, one or more input values among the input values x1, x2, x3, x4, x5 are no longer be acquired and stored.

If referring to FIG. 22, at step 220, the transmission history of the learning-use data to the server 2 stored at the transmission history storage unit 55 is read. Next, at step 221, the types to be acquired are determined from the transmission history of the learning-use data to the server 2. In this case, the lower the frequency of transmission of the learning-use data to the server 2, the more the types of the learning-use data which are acquired at the data acquisition unit 50 is made to decrease. Next, at step 222, the types of the learning-use data which was determined at step 221 to be acquired are acquired. Next, at step 223, the learning-use data which is acquired is stored in the learning-use data storage unit 52. Next, at step 224, it is judged if a transmission condition stands. When it is judged that the transmission condition does not stand, the routine returns to step 222 where the action of acquisition of the learning-use data is continued. On the other hand, when at step 224 it is judged that the transmission condition stands, the processing cycle is ended. At this time, as will be understood from the transmission processing routine performed at the vehicle 1 of FIG. 18, the numbers of nodes and weights of the neural network NN and the learning-use data stored at the learning-use data storage unit 52 are transmitted to the server 2.

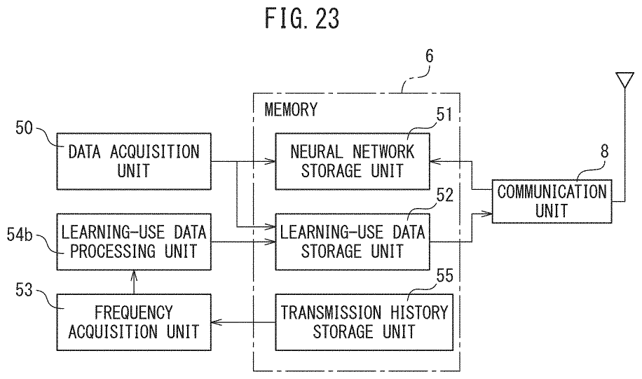

FIG. 23 shows a view of the functional configuration of another example of the vehicle-mounted processing device shown in FIG. 17A. In the example shown in FIG. 23, as the learning-use data changing unit 54 shown in FIG. 17A, a learning-use data processing unit 54b for processing the learning-use data stored in the learning-use data storage 52 is used. In this case, in this example, by processing the learning-use data which finishes being stored in the learning-use data storage unit 52, as shown in FIG. 7D, the lower the frequency of transmission becomes, the more the amount of the learning-use data which finishes being stored in the learning-use data storage unit 52 is made to decrease. Note that, in this case, as explained before, by thinning part of the data sets from the data sets which finish being stored in the learning-use data storage unit 52, the amount of the learning-use data which finishes being stored in the learning-use data storage unit 52 is made to decrease or, alternatively, by thinning the data relating to part of the input values from the data sets which finish being stored in the learning-use data storage unit 52, the amount of the learning-use data which finishes being stored in the learning-use data storage unit 52 is made to decrease.

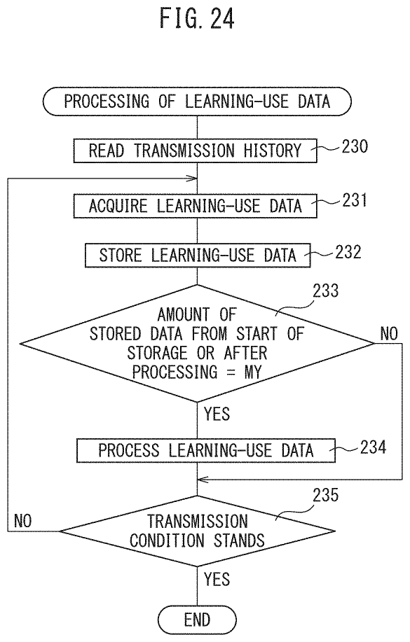

In FIG. 24, the processing routine of the learning-use data performed at the view of the functional configuration shown in this FIG. 23, that is, the processing routine of the learning-use data when making the amount of the learning-use data which finishes being stored in the learning-use data storage unit 52 decrease the lower the frequency of transmission in case of transmitting the learning-use data to the server 2 to perform the learning of the weights of the neural network NN at the server 2, is shown. If referring to FIG. 24, at step 230, the transmission history of the learning-use data to the server 2 stored in the transmission history storage unit 55 is read. Next, at step 231, the learning-use data is acquired. Next, at step 232, the learning-use data which is acquired is stored in the learning-use data storage unit 52. Next, at step 233, it is judged if the amount of stored data from the start of storing the learning-use data to the learning-use data storage unit 52 reaches a preset reference amount MY, or, at the time of after processing the learning-use, it is judged if the amount of stored data after processing of the learning-use data reaches the preset reference amount MY. This reference amount MY is made a value smaller than the reference amount MX at the time of onboard learning shown in FIG. 16. When it is judged that the amount of stored data from the start of storing the learning-use data to the learning-use data storage unit 52 or the amount of stored data after processing the learning-use data does not reach the preset reference amount MY, the routine jumps to step 235.

As opposed to this, if it is judged that the amount of stored data from the start of storing the learning-use data to the learning-use data storage part 52 or the amount of stored data after processing the learning-use data reaches the preset reference amount MY, the routine proceeds to step 234 where the processing of the learning-use data finished being stored in the learning-use data storage unit 52 is performed. At this time, the lower the frequency of transmission, the more the amount of the learning-use data which finishes being stored in the learning-use data storage unit 52 is be made to decrease. In this case, as explained before, by thinning part of the data sets from the data sets which finish being stored in the learning-use data storage unit 52, the amount of the learning-use data which finishes being stored in the learning-use data storage unit 52 is made to decrease or, alternatively, by thinning the data relating to part of the input values from the data sets which finish being stored in the learning-use data storage unit 52, the amount of the learning-use data which finishes being stored in the learning-use data storage unit 52 is made to decrease. Next, at step 235. it is judged if a transmission condition stands. If it is judged that the transmission condition does not stand, the routine returns to step 231 where the action of acquisition of the learning-use data is continued. On the other hand, when at step 235 it is judged that the learning condition stands, the processing cycle is ended. At this time, as will be understood from the transmission processing routine performed at the vehicle 1 of FIG. 18, the numbers of nodes and weights of the neural network NN and the learning-use data stored at the learning-use data storage unit 52 are transmitted to the server 2.

1. A vehicle-mounted processing device of learning-use data in which learning of weights of a neural network is performed on a vehicle or at a server outside of the vehicle, said vehicle-mounted processing device of learning-use data comprising:
a data acquisition unit acquiring data relating to operation of the vehicle,
a neural network storage unit storing a neural network which outputs output values relating to operational control of the vehicle if data which is acquired at the data acquisition unit is input,
a learning-use data storage unit storing learning-use data of weights of the neural network,
a frequency acquisition unit acquiring a frequency of learning of the weights of the neural network on the vehicle or a frequency of transmission of the learning-use data to the server, and
a learning-use data changing unit making an amount of storage per unit time of the learning-use data successively stored in the learning-use data storage unit or an amount of the learning-use data which finishes being stored in the learning-use data storage unit decrease if the frequency of learning of the weights of the neural network on the vehicle or the frequency of transmission of the learning-use data to the server becomes lower.

2. The vehicle-mounted processing device of learning-use data according to claim 1, wherein the learning-use data changing unit makes the learning-use data which finishes being stored in the learning-use data storage unit decrease by processing the learning-use data which finishes being stored in the learning-use data storage unit.

3. The vehicle-mounted processing device of learning-use data according to claim 1, wherein the learning-use data changing unit makes the amount of storage per unit time of the learning-use data successively stored in the learning-use data storage unit decrease by changing the learning-use data which is acquired by the data acquisition unit.

4. The vehicle-mounted processing device of learning-use data according to claim 3, wherein the learning-use data changing unit makes the amount of storage per unit time of the learning-use data successively stored in the learning-use data storage unit decrease by changing a period of cycle of acquisition of the learning-use data which is acquired by the data acquisition unit.

5. The vehicle-mounted processing device of learning-use data according to claim 3, wherein the learning-use data changing unit makes the amount of storage per unit time of the learning-use data successively stored in the learning-use data storage unit decrease by changing types of the learning-use data which are acquired by the data acquisition unit.

6. The vehicle-mounted processing device of learning-use data according to claim 1, wherein said vehicle-mounted processing device of learning-use data comprises a learning unit performing learning of the weights of the neural network.

7. The vehicle-mounted processing device of learning-use data according to claim 1, wherein a learning unit performing learning of the weights of the neural network is provided at the server.

8. The vehicle-mounted processing device of learning-use data according to claim 1, wherein the frequency acquisition unit finds a frequency of learning from a learning history of the weights of the neural network on the vehicle.

9. The vehicle-mounted processing device of learning-use data according to claim 1, wherein the frequency acquisition unit finds a frequency of transmission from a transmission history of the learning-use data to the server.
